(19) United States
(12) Patent Application Publication
(10) Pub. No.: US 2007/0236323 A1
(43) Pub. Date: Oct. 11, 2007

(54) Fusible Conductive Coil with an Insulating Intermediate Coil for Fuse Element

(75) Inventors: Frank Schmidt, Hagen (DE); Manfred Rupalla, Witten (DE)

Correspondence Address: BELL, BOYD & LLOYD LLP, P.O. BOX 1135, CHICAGO, IL, 60690, US

(73) Assignee: WICKMANN-WERKE GMBH, Witten (DE)

(21) Appl. No.: 10/596,829

(22) PCT Filed: Aug. 26, 2004
(86) PCT No.: PCT/EP04/09537

§ 371 Date: Mar. 29, 2007

(30) Foreign Application Priority Data
Feb. 21, 2004 (DE) 20 2004 002 758.5

(51) Int. Cl. H01H 85/04

(52) U.S. Cl. 337/297

(57) ABSTRACT

A fusible conductor for a fuse element includes an electrically insulating core a fusible wire wound about the core and at least one electrically insulating fiber wound about the core parallel to the fusible wire such that the fusible wire is fixed in position so that a short circuit of adjacent turns of the fusible wire is prevented.

The invention relates to a fusible conductor for a fuse element, which has a fusible wire wound about an electrically insulating core.

Fusible conductors for fuses with support characteristics are currently frequently constructed in the form of fusible conductive coils. A fusible conductor, for instance of silver or an alloy thereof, is wound onto a non-conductive support core (e.g. a glass fibre). The more densely the wire is wound, i.e. the more turns are wound per unit of length, the higher is the electrical resistance of the fusible conductor per unit of length and, however, the higher is also the thermal loading per unit of length.

Furthermore, it can occur during handling of the fusible conductive coil and during its installation into a fuse housing that the windings of wire wound parallel to one another are moved on the insulating core so that the winding density varies locally. This results in turn in locally differing thermal loadings. In extreme circumstances, this displacement of the wire windings can also result in electrical short circuits occurring between adjacent windings. Furthermore, “near short circuits” are possible since, depending on the nature of the current loading of the fusible conductor, turn-to-turn faults can then be produced in operation of the fuse.

Experience has shown that in the conventionally wound fusible conductor, a maximum winding density of about 50% may not be exceeded.

It is the object of the invention to provide an improved fusible conductive coil, in which the aforementioned disadvantages are avoided.

This object is solved in accordance with the invention by a fusible conductor for a fuse component with the features of claim 1.

The fusible conductor in accordance with the invention has a fusible wire wound about an electrically insulating core. Wound onto the core parallel to the fusible wire is at least one electrically insulating fibre such that the fusible wire is so fixed in position that a short circuit of adjacent turns is prevented. Depending on the nature of the parallel winding of the fusible wire and the at least one electrically insulating fibre, the fusible wire is prevented to a greater or lesser extent from movement in the longitudinal direction of the core. A short circuit of adjacent turns of the fusible wire is prevented by at least one insulating fibre situated between them.

In a preferred embodiment of the invention, the fusible wire and a insulating fibre are wound closely adjacent to one another. As a result of this embodiment, not only is the short circuiting of the adjacent turns prevented but also uniform winding and positional fixing are also ensured so that the thermal loading per unit of length of the fusible conductor remains constant.

Both the fusible wire and also the insulating fibre preferably have an approximately circular cross section and the ratio of the diameter of the fusible wire to that of the insulating fibre is preferably between ⅓ and 3. In a preferred embodiment, the ratio of the diameter of the fusible wire to that of the insulating fibre is between 1 and 3, i.e. the diameter of the fusible wire is at least as large as that of the insulating fibre. The result of this is firstly the advantage that the outer surfaces of the fusible wire project beyond those of the electrically insulating fibre so that a reliable contact is possible, even without soldering. Furthermore, a relatively high ratio of the diameter of the fusible wire to that of the insulating fibre permits a greater winding density. The value 3 constitutes approximately an upper limit, which still ensures reliable insulation of adjacent turns.

In one embodiment, the insulating fibre deforms (from an initially approximately circular cross section) during winding onto the core and is, for instance, flattened. The fibre should then be so selected that a spacing between the fusible wire turns is maintained which is preferably between 0.2-2 times the diameter of the fusible wire.

In a preferred embodiment, the core, on which the fusible wire and the insulating fibre are wound parallel, has a circular cross section and the cross sectional dimensions of the insulating fibre, e.g. its diameter in the case of a circular cross section, are smaller than the diameter of the core. The ratio of the diameter of the core to that of the insulating fibre is preferably between 3 and 8, for instance 5.

Conventional materials, such as silver, silver-copper alloys, alloys of silver, copper, tin and other metals, are used as the materials for the fusible wire. Glass, ceramic material and temperature resistant materials are possible as the material of the insulating fibre. Similar materials can be used for the core. The material of the insulating fibre is flexible and that of the core can also be a rigid body. In a preferred embodiment, the insulating fibre consists of one or more parallel glass fibres or one or more ceramic fibres. The core preferably also consists of one or more glass fibres.

Advantageous/or preferred embodiments of the invention are characterised in the dependent claims.

The invention will be described in more detail below with reference to a preferred exemplary embodiment illustrated in the drawings, in which;

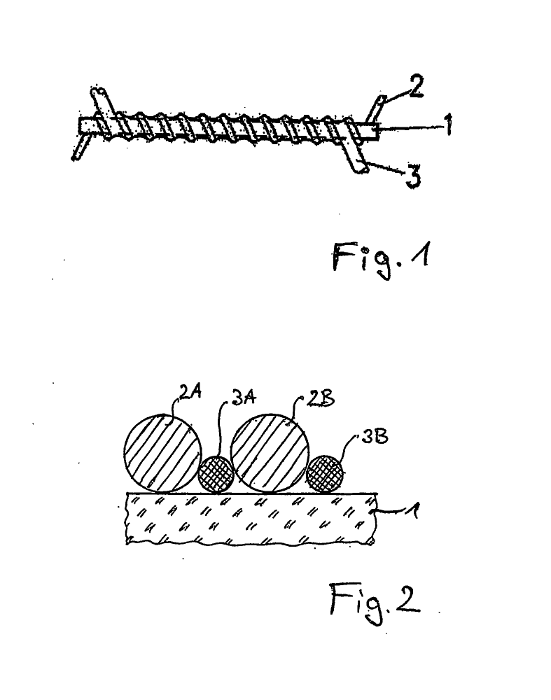

FIG. 1 is a schematic side view of the fusible conductor in accordance with the invention; and

FIG. 2 is a schematic view showing a portion of two parallel fusible wire turns in section.

FIG. 1 is a schematic view of a fusible conductor in accordance with the invention, in which both a fusible wire 2 and also an insulating fibre 3 are wound parallel about an electrically insulating core 1 In the illustrated embodiment, the fusible wire 2 and the insulating fibre 3 are wound closely adjacent to one another. The insulating fibre initially has an approximately circular cross section and deforms during the winding process to form a flattened strip, the width of which is approximately twice the diameter of the fusible wire 2.

FIG. 2 is a schematic sectional view of a portion of another embodiment of a surface of the insulating core 1 wound with a fusible wire and an insulating fibre. Two adjacent turns of each are shown. The fusible wire and the insulating fibre have an approximately circular section, even after the winding process, the diameter of the fusible wire being approximately twice that of the insulating fibre. The turns are wound closely adjacent to one another. The adjacent turns of the fusible wire are designated 2A and 2B and the adjacent turns of the insulating fibre are designated 3A and 3B. In the mode of winding illustrated in FIG. 2, it may be calculated that a spacing is produced between the adjacent turns of the fusible wire of about 0.4 times the diameter. Such a high winding density can not be achieved with the conventional method. If, for instance, in an alternative embodiment, the diameter of the insulating fibre were ⅓ of the diameter of the fusible wire, a calculation shows that a spacing would be produced between the turns of the fusible wire of about 0.16 times the diameter of the fusible wire.

When selecting the dimensions and cross sectional profiles (circular or other cross section) of the fusible wire and of the insulating fibre, attention is paid in particular to the fact that good contact is possible with the external surface of the fusible wire, that only a small amount of heat is dissipated into the parallel wound insulating material and that simple as possible manufacture is ensured. As a result of the high winding densities (turns per unit length) which may be achieved in accordance with the invention, fuse components with improved characteristics, may be achieved, particularly a relatively small rated current and relatively high pulse resistance, for instance a rated current of 1.6 A and a pulse resistance of up to above 1 kA. Furthermore, the fusible conductor in accordance with the invention facilitates the manufacture of the fuse because displacement of the turns is avoided during further processing.

1 to 11. (canceled)

12. A fusible conductor for a fuse element, said fusible conductor comprising:
an electrically insulating core;
a fusible wire wound about the core; and
at least one electrically insulating fibre wound about the core parallel to the fusible wire such that the fusible wire is fixed in position so that a short circuit of adjacent turns of the fusible wire is prevented.

13. The fusible conductor of claim 12, wherein the fusible wire and one insulating fibre are wound closely adjacent to one another.

14. The fusible conductor of claim 13, wherein both fusible wires and also the insulating fibre have an approximately circular cross section and the ratio of the diameter of the fusible wire to that of the insulating fibre is between ⅓ and 3.

15. The fusible conductor of claim 14, wherein the ratio of the diameter of the fusible wire to that of the insulating fibre is between 1 and 3.

16. The fusible conductor of claim 13, wherein the fusible wire has an approximately circular cross section and wherein the insulating fibre is situated between adjacent turns of the fusible wire such that the spacing between the turns is 0.2 to 2 times the diameter of the fusible wire.

17. The fusible conductor of claim 16, wherein the spacing between adjacent turns is smaller than the diameter of the fusible wire.

18. The fusible conductor of claim 16, wherein the outer surface of the wound fusible wire projects beyond the outer surface of the insulating fibre.

19. The fusible conductor of claim 14, wherein the core has a circular cross section and the cross sectional dimensions of the insulating fibre are smaller than the diameter of the core.

20. The fusible conductor of claim 12, wherein the insulating fibre consists of one or more glass fibres.

21. The fusible conductor of claim 12, wherein the insulating fibre consists of one or more ceramic fibres.

22. The fusible conductor of claim 12, wherein the core consists of one or more glass fibres.
